(19) United States
(12) Patent Application Publication
(10) Pub. No.: US 2026/0189724 A1
(43) Pub. Date: Jul. 2, 2026

(54) VIDEO FRAME PREDICTION METHOD AND DEVICE

(71) Applicant: Beijing Zitiao Network Technology Co., Ltd., Beijing (CN)

(72) Inventors: Zhiyi ZHOU, Beijing (CN); Weihui DENG, Beijing (CN); Meijia SONG, Beijing (CN); Hanbang LIANG, Beijing (CN); Zhengting LI, Beijing (CN); Zhen WANG, Beijing (CN)

(21) Appl. No.: 19/419,930

(22) Filed: Dec. 15, 2025

(30) Foreign Application Priority Data
Dec. 31, 2024 (CN) 202411999505.3

(51) Int. Cl. H04N 19/503; H04N 19/137; H04N 19/33

(52) U.S. Cl. CPC H04N 19/503; H04N 19/137; H04N 19/33

(57) ABSTRACT

The embodiment of the present disclosure provides a video frame prediction method and device. The method includes: obtaining first video frame information and second video frame information of a target video to be predicted, where the first video frame information includes accumulation trend information of each historical video frame relative to a first video frame and transient variation information of each historical video frame relative to a last time video frame of the historical video frame, the historical video frame includes a second time video frame to a t−1-th time video frame of the target video, and the second video frame information includes encoding information of a t-th time video frame of the target video; where the t-th time is a current time and t is a positive integer; predicting third video frame information of the t-th time video frame according to the first video frame information, the second video frame information and a video frame prediction model; and predicting a t+1-th time video frame of the target video according to the encoding information of the t-th time video frame and the third video frame information.

### CROSS REFERENCE TO RELATED APPLICATIONS

This present application claims the benefit of priority to Chinese Application No. 202411999505.3, filed on Dec. 31, 2024, the entire contents of which are incorporated herein by reference.

### TECHNICAL FIELD

The embodiment of the present disclosure relates to the field of Internet technology, in particular to a video frame prediction method and device.

### BACKGROUND

With the development of multimedia technology, the video frame sequence prediction task which is more and more extensively applied, plays an important role in scenarios such as video codec, weather forecasting and automatic driving. The so-called video frame sequence prediction means inputting several consecutive video frames in the history, and learning the spatio-temporal correlation of the input sequence using a predictive representation ability of a model, so as to predict and generate several consecutive video frames in the future.

In the related art, the general video prediction algorithm is to down-sample the input video frame sequence into a low-dimensional feature space, predict a corresponding feature state in the future through a state transition unit, and then restore the feature state to the originally input spatial scale through an up-sampling operation.

### SUMMARY

The embodiment of the present disclosure provides a video frame prediction method and device.

In a first aspect, the embodiment of the present disclosure provides a video frame prediction method. The method includes:
obtaining first video frame information and second video frame information of a target video to be predicted, where the first video frame information includes accumulation trend information of each historical video frame relative to a first video frame and transient variation information of each historical video frame relative to a last time video frame of the historical video frame, the historical video frame includes a second time video frame to a t−1-th time video frame of the target video, and the second video frame information includes encoding information of a t-th time video frame of the target video; where the t-th time is a current time and t is a positive integer;
predicting third video frame information of the t-th time video frame according to the first video frame information, the second video frame information and a video frame prediction model, where the third video frame information includes accumulation trend information of the t-th time video frame relative to the first video frame and transient variation information of the t-th time video frame relative to a t−1-th time video frame; and
predicting a t+1-th time video frame of the target video according to the encoding information of the t-th time video frame and the third video frame information.

In a second aspect, the embodiment of the present disclosure provides a video frame prediction device. The device includes:
an obtaining unit configured to obtain first video frame information and second video frame information of a target video to be predicted, where the first video frame information includes accumulation trend information of each historical video frame relative to a first video frame and transient variation information of each historical video frame relative to a last time video frame of the historical video frame, the historical video frame includes a second time video frame to a t−1-th time video frame of the target video, and the second video frame information includes encoding information of a t-th time video frame of the target video; where the t-th time is a current time and t is a positive integer;
a first prediction unit configured to predict third video frame information of the t-th time video frame according to the first video frame information, the second video frame information and a video frame prediction model, where the third video frame information includes accumulation trend information of the t-th time video frame relative to the first video frame and the transient variation information of the t-th time video frame relative to the t−1-th time video frame; and
a second prediction unit configured to predict a t+1-th time video frame of the target video according to the encoding information of the t-th time video frame and the third video frame information.

In a third aspect, the embodiment of the present disclosure provides an electronic device. The electronic device includes: a processor and a memory;
where the memory stores computer-executable instructions; and
the processor executes the computer-executable instructions stored in the memory, so that the at least one processor performs the video frame prediction method as described above in the first aspect and various possible designs of the first aspect.

In a fourth aspect, the embodiment of the present disclosure provides a computer-readable storage medium. The computer-readable storage medium has computer-executable instructions stored thereon that, when executed by a processor, implement the video frame prediction method as described above in the first aspect and various possible designs of the first aspect.

In a fifth aspect, the embodiment of the present disclosure provides a computer program product. The computer program product includes a computer program that, when executed by a processor, implements the video frame prediction method as described above in the first aspect and various possible designs of the first aspect.

In the video frame prediction method and device provided by this embodiment, the method includes: obtaining first video frame information and second video frame information of a target video to be predicted, where the first video frame information includes accumulation trend information of each historical video frame relative to a first video frame and transient variation information of each historical video frame relative to a last time video frame of the historical video frame, the historical video frame includes a second time video frame to a t−1-th time video frame of the target video, and the second video frame information includes encoding information of a t-th time video frame of the target video; where the t-th time is a current time and t is a positive integer; predicting third video frame information of the t-th time video frame according to the first video frame information, the second video frame information and a video frame prediction model, where the third video frame information includes accumulation trend information of the t-th time video frame relative to the first video frame and transient variation information of the t-th time video frame relative to the t−1-th time video frame; and predicting a t+1-th time video frame of the target video according to the encoding information of the t-th time video frame and the third video frame information.

### BRIEF DESCRIPTION OF THE DRAWINGS

In order to more explicitly explain the technical solutions in the embodiments of the present disclosure or the related art, the accompanying drawings required to be used in the description of the embodiments or the related art will be briefly introduced below. Obviously, the accompanying drawings described below are some of the embodiments of the present disclosure. For those of ordinary skill in the art, other accompanying drawings may also be obtained according to these accompanying drawings on the premise that no inventive effort is involved.

FIG. 1 is a schematic view of an application scenario of a video frame prediction method provided by the embodiment of the present disclosure;

FIG. 2 is a first flow chart of a video frame prediction method provided by the embodiment of the present disclosure;

FIG. 3 is a first schematic structural view of a codec architecture used by a STANet model provided by the embodiment of the present disclosure;

FIG. 4 is a first schematic structural view of a spatio-temporal attention cell STA Cell provided by the embodiment of the present disclosure;

FIG. 5 is a first schematic structural view of the STANet model provided by the embodiment of the present disclosure;

FIG. 6 is a first schematic structural view of the MAF model provided by the embodiment of the present disclosure;

FIG. 7 is a first schematic view of a model structure of CGU provided by the embodiment of the present disclosure;

FIG. 8 is a schematic structural view of a video frame prediction device provided by the embodiment of the present disclosure;

FIG. 9 is a schematic structural view of an electronic device provided by the embodiment of the present disclosure.

### DETAILED DESCRIPTION

In order to make the objects, technical solutions and advantages of the embodiments of the present disclosure more explicit, the technical solution in the embodiment of the present disclosure will be explicitly and fully described below in conjunction with the accompanying drawings in the embodiment of the present disclosure. Apparently, the embodiments described are some embodiments of the present disclosure, rather than all of the embodiments. On the basis of the embodiments of the present disclosure, all the other embodiments obtained by those of ordinary skill in the art on the premise that no inventive effort is involved shall fall into the protection scope of the present disclosure.

It is to be noted that, the user information (including but not limited to user equipment information, user personal information and the like) and the data (including but not limited to data for analysis, stored data, displayed data and the like) involved in one or more embodiments of this specification are all information and data authorized by users or adequately authorized by all parties, and the collection, use and processing of relevant data need to comply with relevant laws, regulations and standards, and corresponding operation accesses are provided for users to choose authorization or refusal.

With the development of multimedia technology, the video frame sequence prediction task which is more and more extensively applied, plays an important role in scenarios such as video codec, weather forecasting and automatic driving. The so-called video frame sequence prediction means inputting several consecutive video frames in the history, and learning the spatio-temporal correlation of the input sequence using the predictive representation ability of the model, so as to predict and generate several consecutive video frames in the future.

During the process of video frame transmission, there are often two common spatio-temporal dynamics: a local transient variation and a global accumulation trend. Specifically, if the dynamic changes in the video are reviewed at a small spatial scale, it may be found that these small areas have different dynamics from each other, which are referred to as a local transient variation. At the same time, the main object motion in the video may be presented by a deterministic tensor, which is often different from each local transient variation, and this motion is referred to as a global accumulation trend. From the perspective of vector decomposition, the apprehension of the accumulation trend depends on the accurate representation of the transient variation in each small range, and the accurate capture of the transient variation in each small range also needs to rectify the accumulation trend. Therefore, when spatio-temporal dynamics of a video frame sequence are captured, it is critical to perform deterministic unified modeling on the transient variation and the accumulation trend.

In the traditional long-short-term memory network (referred to as LSTM for short) model, there are two memory states, long-term and short-term. These two memory states are intertwined, and the short-term memory state is generated from the long-term memory state in each cycle unit via the gated mechanism. This operation mechanism results in that the two states are very likely to be subject to mutual pollution and interference during the iterative process of loop backtracking, which makes the learning of both long-term memory and short-term memory deviate.

Further, the general video prediction algorithm is to down-sample the input video frame sequence into a low-dimensional feature space, predict a corresponding feature state in the future through a state transition unit, and then restore the feature state to the originally input spatial scale through an up-sampling operation.

However, since a relatively serious information loss phenomenon may occur during the process of down-sampling and state transition operation, when the down-sampled original features are supplemented to the up-sampling end, there may be apparent spatial position deviation due to different times corresponding to the up-sampled features and the down-sampled features, which may result in that feature supplementation of residual connection may provide the information that the predicted video frame brings a circle of historical times in the opposite direction of motion, which is referred to as a “ghost” effect. Thus it may be seen that, the video frame predicted by the above video prediction algorithm has a poor accuracy.

For the technical problem in the related art, the technical concept of the inventors is as follows: the present disclosure relates to a novel Spatio-temporal Aware Network (STANet, Spatio-temporal attention neural network) model. This model depends on the structure of the recurrent neural network, and the nonlinear representation ability of the model is enhanced by stacking multiple layers of Spatio-temporal Attention Cells (STA Cells). STA Cell contains a Motion Aware Fusion Module (referred to as a MAF Module for short), which may aggregate two different spatio-temporal dynamics of the transient variation and the accumulation trend, under the supervision of the attention mechanism, so that the two spatio-temporal dynamics may not only supervise respective synthesis processes for each other, but also provide necessary information supplements for each other.

In addition, in order to overcome the “ghost” effect that may appear in the predicted video frame, the present disclosure designs a Context Gated Unit (referred to as GCU for short). Based on the gated features of the sigmoid activation function, the cell structure adaptively controls the interactive flow of the down-sampling and up-sampling information, so that the final prediction state may not only receive meaningful information supplement from the down-sampling end, but also shield meaningless “ghost” information.

Accordingly, the specific steps include: first, obtaining first video frame information and second video frame information of a target video to be predicted, where the first video frame information includes the accumulation trend information of each historical video frame relative to a first video frame and the transient variation information of each historical video frame relative to a last time video frame of the historical video frame, the historical video frame includes a second time video frame to a t−1-th time video frame of the target video, and the second video frame information includes encoding information of a t-th time video frame of the target video; where the t-th time is a current time and t is a positive integer. Then, the third video frame information of the t-th time video frame is predicted according to the first video frame information, the second video frame information and a video frame prediction model, where the third video frame information includes the accumulation trend information of the t-th time video frame relative to the first video frame and the transient variation information of the t-th time video frame relative to the t−1-th time video frame. Finally, a t+1-th time video frame of the target video is predicted according to the encoding information of the t-th time video frame and the third video frame information.

In this technical solution, since the video frame prediction model combines the two spatio-temporal dynamics of the transient variation information and the accumulation trend information implicated in the video frame sequence, the two spatio-temporal dynamics may not only supervise respective synthesis processes for each other, but also provide necessary information supplements for each other, thereby improving the accuracy of predicting a video frame. Moreover, when the t+1-th time video frame is predicted, the encoding information of the t-th time video frame is combined with the transient variation information of the t-th time video frame relative to the last time video frame, which may avoid apparent spatial position deviation, thereby further improving the accuracy of predicting a video frame.

The application scenario of the embodiment of the present disclosure will be explained below:

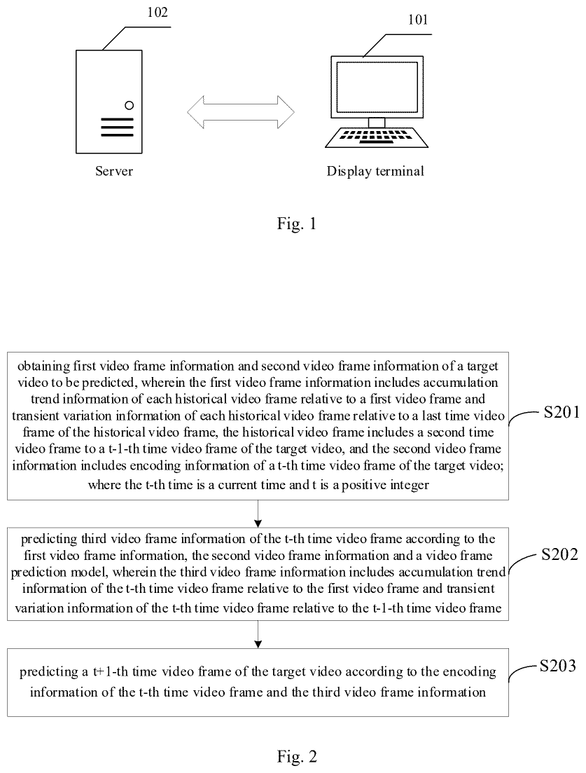

The video frame prediction method provided by the embodiment of the present disclosure may be applied to various video frame prediction scenarios such as video codec, weather forecasting and automatic driving. FIG. 1 is a schematic view of an application scenario of a video frame prediction method provided by the embodiment of the present disclosure. As shown in FIG. 1, the vehicle may send a video frame prediction request to a server 102 through a display terminal 101 during the process of automatic driving. The server 102 receives the video frame prediction request, predicts the future time video frame through the video frame prediction method provided by the embodiment of the present disclosure, and returns the prediction result of the future time video frame to the display terminal 101 for display.

A specific implementation process of the video frame prediction method and device involved in the embodiment of the present disclosure will be described below, and some examples which are only exemplary are not limited. The performing body of the video frame prediction method according to the embodiment of the present disclosure is an electronic device, which may be a terminal, a server or the like.

FIG. 2 is a first flow chart of a video frame prediction method provided by the embodiment of the present disclosure. As shown in FIG. 2, the video frame prediction method may include:

In S201, the first video frame information and the second video frame information of a target video to be predicted are obtained, where the first video frame information includes accumulation trend information of each historical video frame relative to a first video frame and transient variation information of each historical video frame relative to a last time video frame of the historical video frame, the historical video frame includes a second time video frame to a t−1-th time video frame of the target video, and the second video frame information includes encoding information of a t-th time video frame of the target video; where the t-th time is a current time and t is a positive integer.

In the embodiment of the present disclosure, the target video may be any type of video. For example, the target video may be an assisted driving video of a vehicle, a weather forecast video, or a short video on the Internet platform. The value of t is not specifically limited in this step.

In some embodiments, in order to reduce the computational complexity of the state transition operation, the model first maps the input video frame to a low-dimensional latent feature space through an encoder, and obtains the encoding information of the t-th time video frame. Alternatively, as shown in FIG. 4, the encoder is down-sampled by a convolution operation with a step length of 2, and a Batch Normalization Layer (referred to as BN for short) is used to shrink the data range to a range with a mean value of 0 and a variance of 1 after each down-sampling operation, so as to maintain the data distribution range in a stable state.

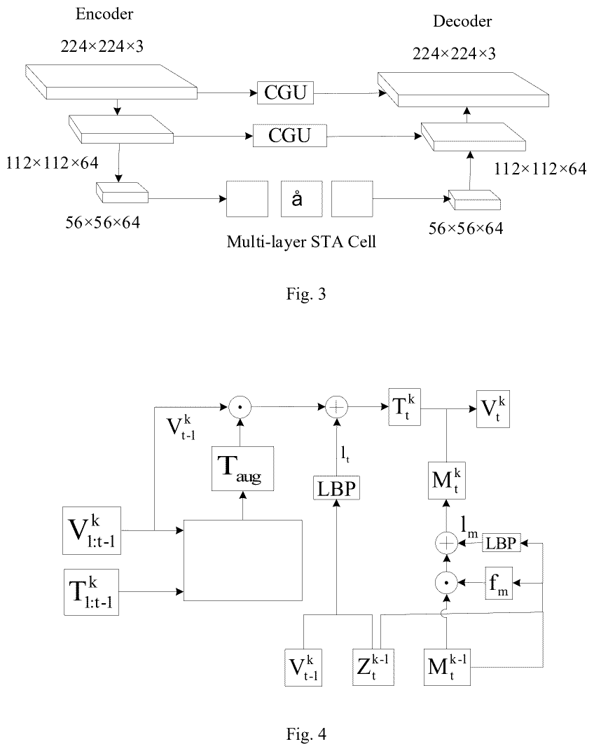

For instance, FIG. 3 is a schematic view of a codec architecture used by STANet. The input video frame is represented by the RGB three-channel color image with a spatial resolution of 224×224. At the decoding end, the decoder used by STANet consists of bilinear interpolation and a corresponding normalization layer. The decoder up-samples the predicted state features to the original resolution space, and then calculates a difference between the video frame sequence generated by prediction and the real label sequence pixel by pixel to calculate a loss function for model training. For example, for a color video frame of 224×224×3, the encoder down-samples it into the data dimensions of 112×112×64 and 56×56×64 in two stages. Where, the encoding information of 56×56×64 data dimension is used as the input of the video frame prediction model (multiple layers of spatio-temporal attention cell STA Cell). At this time, the encoding information of 56×56×64 data dimension is the input

$${Z}_{t}^{1}$$

of the first layer spatio-temporal attention cell STA Cell. During the decoding process, the predicted feature state (56×56×64) is also up-sampled into 112×112×64 and 224×224×3 data dimensions in two stages.

For instance, as shown in FIG. 4, for the k-th layer spatio-temporal attention cell STA Cell, the accumulation trend information of each historical video frame in the k-th layer relative to the first video frame may be presented as:

$${T}_{1 : t - 1}^{k} .$$

The transient variation information of each historical video frame in the k-th layer relative to a last time video frame of the historical video frame may be presented as:

$${V}_{1 : t - 1}^{k} .$$

The encoding information of the t-th time video frame of the target video of the k−1-th layer may be presented as

$${Z}_{t}^{k - 1} .$$

It is to be noted that, the information of multiple layers of spatio-temporal attention cell STA Cell is continuous. Where, the input

$${Z}_{t}^{k - 1}$$

of the k-th layer spatio-temporal attention cell is also the output

$${V}_{t}^{k - 1}$$

of the k−1-th layer spatio-temporal attention cell STA Cell.

In S202, the third video frame information of the t-th time video frame is predicted according to the first video frame information, the second video frame information and a video frame prediction model, where the third video frame information includes accumulation trend information of the t-th time video frame relative to the first video frame and transient variation information of the t-th time video frame relative to the t−1-th time video frame.

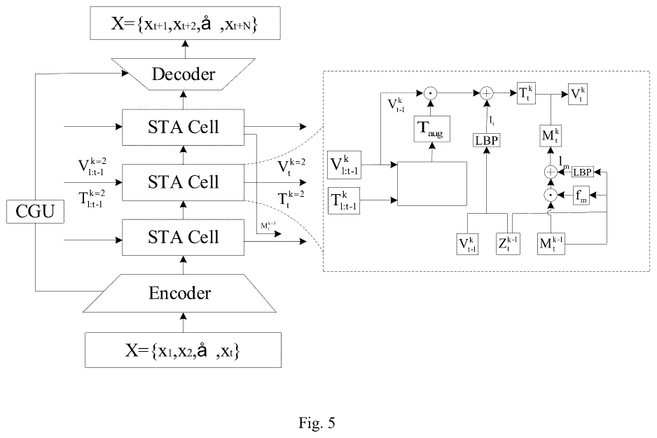

In the embodiment of the present disclosure, the video frame prediction model includes multiple layers of spatio-temporal attention cells arranged longitudinally; where, the key module of the spatio-temporal attention cell is Multi-scale Attention Fusion Model (MAF Module), and this module is relied upon to achieve unified modeling of two spatio-temporal dynamics. As shown in FIG. 5, the video frame prediction model includes three layers of spatio-temporal attention cells STA Cell arranged longitudinally.

In some embodiments, the predicting third video frame information of the t-th time video frame according to the first video frame information, the second video frame information and a video frame prediction model may include: for each layer of spatio-temporal attention cell, predicting the accumulation trend information of the t-th time video frame relative to the first video frame of the current layer and the transient variation information of the t-th time video frame relative to the t−1-th time video frame of the current layer according to a multi-scale attention fusion MAF model of the layer of spatio-temporal attention cell, the accumulation trend information of each historical video frame relative to the first video frame in the current layer, the transient variation information of each historical video frame relative to a last time video frame of the historical video frame in the current layer and the encoding information of the t-th time video frame of the target video in the previous layer; and determining the accumulation trend information of the t-th time video frame relative to the first video frame of the last layer as the accumulation trend information of the t-th time video frame relative to the first video frame, and determining the transient variation information of the t-th time video frame relative to the t−1-th time video frame of the last layer as the transient variation information of the t-th time video frame relative to the t−1-th time video frame.

In some embodiments, the predicting the accumulation trend information of the t-th time video frame relative to the first video frame of the current layer and the transient variation information of the t-th time video frame relative to the t−1-th time video frame of the current layer according to a multi-scale attention fusion MAF model of the layer of spatio-temporal attention cell, the accumulation trend information of each historical video frame relative to the first video frame in the current layer, the transient variation information of each historical video frame relative to a last time video frame of the historical video frame in the current layer and the encoding information of the t-th time video frame of the target video in the previous layer includes steps (1) to (3):

(1) according to the multi-scale attention fusion MAF model, fusing the accumulation trend information of each historical video frame relative to the first video frame in the current layer and the transient variation information of each historical video frame relative to a last time video frame of the historical video frame in the current layer to determine a first variation information of the t-th time video frame in the current layer in the time dimension; and determining a second variation information of the t-th time video frame in the current layer in the spatial dimension according to the encoding information of the t-th time video frame in the previous layer and the transient variation information of the t−1-th time video frame relative to the t−2-th time video frame in the current layer.

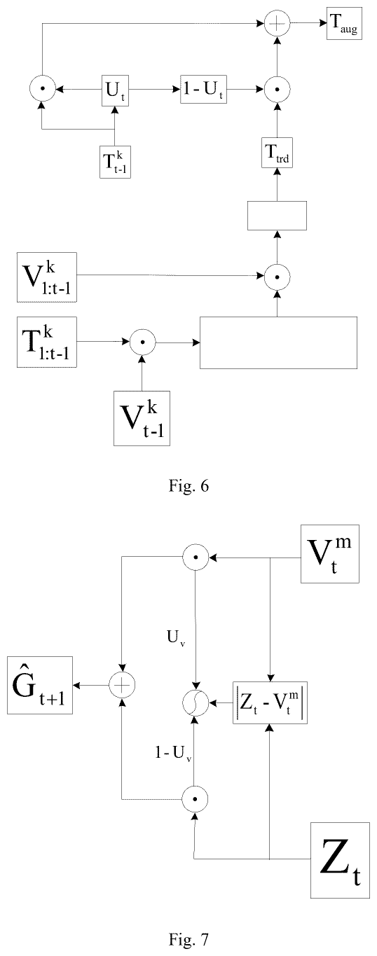

Alternatively, the schematic structural view of the MAF model is shown in FIG. 6, and the input of the MAF Module consists of two parts, that is, the accumulation trend T and the transient variation V of the past historical times stored using an array. Specifically, considering that the transient variation has a more concrete spatial representation, the MAF Module first performs calculation of the attention mechanism on the transient variation at the current time t and the transient variation at the past historical times (from the second time video frame to the t−1 time video frame) to obtain an attention score. It is to be noted that, the calculation of the attention mechanism is to help the neural network to capture the global representation in order to observe enough information under a large window. Here, in order to reduce the computational complexity, the calculation of the attention mechanism uses the form of Hadamard product instead of matrix multiplication. After the attention score is obtained, the aggregation of the accumulation trend T is supervised in the time dimension through the attention score, so as to obtain a comprehensive spatio-temporal dynamic T_{trd}. This state contains the transient variation and the accumulation trend in the past time, and at the same time allows that the two spatio-temporal dynamics are not subject to mutual interference and influence during the synthesization.

Accordingly, the according to the multi-scale attention fusion MAF model, fusing the accumulation trend information of each historical video frame relative to the first video frame in the current layer and the transient variation information of each historical video frame relative to a last time video frame of the historical video frame in the current layer to determine the first variation information of the t-th time video frame in the current layer in the time dimension includes:

In S11, an attention weight of each historical video frame in the current layer is determined according to the transient variation information of each historical video frame relative to a last time video frame of the historical video frame in the current layer.

In some embodiments, as shown in FIG. 6, the current layer is the k-th layer; Accordingly, this step may include: determining an attention weight of each historical video frame in the current layer according to the transient variation information of each historical video frame relative to a last time video frame of the historical video frame in the current layer and the following formula I;

$${V}_{w} = {W}_{v} * {V}_{t - 1}^{k} ; \qquad Formula I$$

$${q}_{j} = {V}_{w} ⊙ {V}_{j}^{k} , j = 1 , 2 , … , t - 1$$

$${α}_{j} = \frac{{e}^{{q}_{j}}}{{\sum }_{j = 1}^{t - 1} {e}^{{q}_{j}}}$$

Where, αⱼ represents the attention weight of each historical video frame in the current layer;

$${V}_{j}^{k}$$

represents the transient variation information of each historical video frame relative to a last time video frame of the historical video frame in the current layer;

$${V}_{t - 1}^{k}$$

represents the transient variation information of the t−1-th time video frame relative to the t−2-th time video frame in the current layer. Wᵥ is a convolution operation, and its parameters may be learned in training. qⱼ(j=1, 2, . . . , t−1) is the attention score calculated from the transient variation information of the t−1-th time video frame and the transient variation information of all the past times of video frames.

It is to be noted that, as shown in FIG. 6, the third formula in the above formula I is a softmax function, and the purpose is to map the attention scores calculated in the previous step into the attention distributions with numerical values ranging from 0 to 1 after this function, and the sum of all the attention distributions is 1.

In S12, according to the attention weight of each historical video frame in the current layer, the accumulation trend information of each historical video frame relative to the first video frame in the current layer in the time dimension is aggregated, to determine a global motion trend of the t−1-th time video frame in the current layer in the time dimension.

Alternatively, after the attention distribution is obtained, the MAF Module selectively extracts information from the accumulation trend T through this attention distribution. The specific steps may include: according to the attention weight of each historical video frame in the current layer, aggregating the accumulation trend information of each historical time video frame in the current layer relative to the first video frame in the time dimension, to determine a global motion trend of the t−1-th time video frame in the current layer in the time dimension and the following formula II.

$${T}_{trd} = LayerNorm ( {\sum }_{j = 1}^{t - 1} {α}_{j} ⊙ {T}_{j}^{k} ) , j = 1 , 2 , … , t - 1 \qquad Formula II$$

Where, T_{trd} represents the global motion trend of the t−1-th time video frame in the current layer in the time dimension, that is, the accumulation trend T of the k-th layer spatio-temporal attention cell (STA Cell), which is aggregated in the time dimension according to the calculated attention distribution. After aggregation, the data is subject to a layer normalization operation to maintain a distribution range of the data in a stable interval, so as to prevent the consequence of a training failure caused by the overflow of the data range during the training process. T_{trd} may be regarded as a comprehensive global motion trend, which includes a concrete representation extracted from the transient variation and possesses an abstract feature representation fused from the accumulation trend, which comprehensively reflects the model's ability to capture complex spatio-temporal dynamic changes.

In S13, the global motion trend of the t−1-th time video frame in the current layer in the time dimension and the accumulation trend information of the t−1-th time video frame relative to the first video frame in the current layer are combined to determine the first variation information of the t-th time video frame in the current layer in the time dimension.

In some embodiments, T_{trd} is a comprehensive representation of the global motion trend of historical time video frames. In addition to T_{trd}, the local information at the t−1-th time is also necessarily introduced as an information supplement to improve the overall presentation of the motion trend. Inspired by Gated Recurrent Unit (GRU), a structure based on a gated mechanism is introduced herein so as to control the information to select appropriate proportions of features from the overall trend of the past historical information and the current time local features respectively for fusion.

Alternatively, as shown in FIG. 6, the control information may be presented as Uₜ and 1−Uₜ. Accordingly, this step may include: combining the global motion trend of the t−1-th time video frame in the current layer in the time dimension, the accumulation trend information of the t−1-th time video frame relative to the first video frame in the current layer and the following formula III to determine the first variation information of the t-th time video frame in the current layer in the time dimension.

$${U}_{t} = σ ( {W}_{t} * {T}_{t - 1}^{k} ) ; \qquad Formula III$$

$${T}_{a u g} = {U}_{t} ⊙ {T}_{t - 1}^{k} + ( 1 - {U}_{t} ) ⊙ {T}_{trd}$$

In the above formula III, Tₜᵣd represents the global motion trend of the t−1-th time video frame in the current layer in the time dimension;

$${T}_{t - 1}^{k}$$

represents the accumulation trend information of the t−1-th time video frame relative to the first video frame in the current layer; σ represents sigmoid activation function, Wt is a learnable 2D convolution operator, and Ut is a gated tensor, which has a numerical range stretched to 0 to 1 by sigmoid function, and adaptively controls the proportion of information selected from

$${T}_{t - 1}^{k}$$

and T_{trd} respectively. Where, the first variation information T_{aug} may be regarded as an enhanced motion information state, which not only contains a comprehensive representation of the transient variation and the accumulation trend in the past historical times, but also has the local information of t−1-th time state.

The above motion information mainly includes the modeling of the time dimension, and for a video prediction task, appropriate spatial information should also be introduced as a supplement to improve the deterministic spatio-temporal representation. For this purpose, STANet introduces a Locally Preserved Block (LPB) to provide local spatial information for a spatio-temporal representation. Since STA Cell contains a normalization operation after each layer of convolution operation to pull the data distribution into the data distribution range with a mean value of 0, and this data distribution is maintained not to be destructed in the future, and LPB first modulates the input data into the distribution range of [−1, 1] through a tanh function. In LPB, the sigmoid function still serves as a gated function to control the flow of the input information. The specific formula is presented as follows:

Accordingly, the determining the second variation information of the t-th time video frame in the current layer in the spatial dimension according to the encoding information of the t-th time video frame in the previous layer and the transient variation information of the t−1-th time video frame relative to the t−2-th time video frame in the current layer may include: determining a first convolution operator corresponding to the encoding information of the t-th time video frame in the previous layer and a second convolution operator corresponding to the transient variation information of the t−1-th time video frame relative to the t−2-th time video frame in the current layer; and determining the second variation information of the t-th time video frame in the current layer in the spatial dimension according to a product of the encoding information of the t-th time video frame in the previous layer and the first convolution operator, a product of the transient variation information of the t−1-th time video frame relative to the t−2-th time video frame in the current layer and a local spatial information calculation model.

For instance, the local spatial information calculation model is: LPB(⋅)=σ(⋅)⊙tanh(⋅). The encoding information of the t-th time video frame in the previous layer may be presented as

$${Z}_{t}^{k - 1} ,$$

and the transient variation information of the t−1-th time video frame relative to the t−2-th time video frame in the current layer may be presented as:

$${V}_{t - 1}^{k} .$$

The first convolution operator may be presented as: W_{zt}. The second convolution operator may be presented as: W_{yt}. Accordingly, according to a product of the encoding information of the t-th time video frame in the previous layer and the first convolution operator, a product of the transient variation information of the t−1-th time video frame relative to the t−2-th time video frame in the current layer and the local spatial information calculation model, the second variation information of the t-th time video frame in the current layer is determined as:

$$lt = LPB ( {W}_{z t} * {Z}_{t}^{k - 1} + {w}_{v t} * {V}_{t - 1}^{k} + {b}_{l} ) .$$

(2) The accumulation trend information of the t-th time video frame relative to the first video frame of the current layer is predicted according to the first variation information, the second variation information and the accumulation trend information of the t−1-th time video frame relative to the first video frame of the current layer.

Alternatively, the predicting the accumulation trend information of the t-th time video frame relative to the first video frame of the current layer according to the first variation information, the second variation information and the accumulation trend information of the t−1-th time video frame relative to the first video frame of the current layer includes: performing dot product operation on the accumulation trend information of the t−1-th time video frame relative to the first video frame of the current layer and the first variation information to obtain the first vector information; and predicting the accumulation trend information of the t-th time video frame relative to the first video frame of the current layer according to a sum of the first vector information and the second variation information.

For instance, the accumulation trend information of the t-th time video frame in the current layer relative to the first video frame may be presented as:

$${T}_{t}^{k} = {T}_{t - 1}^{k} ⊙ {T}_{a u g} + {l}_{t} .$$

(3) The transient variation information of the t-th time video frame relative to the t−1-th time video frame of the current layer is predicted according to the accumulation trend information of the t-th time video frame relative to the first video frame of the current layer.

Alternatively, the predicting the transient variation information of the t-th time video frame relative to the t−1-th time video frame of the current layer according to the accumulation trend information of the t-th time video frame relative to the first video frame of the current layer includes:

In S31, the spatio-temporal feature information at the t-th time in the current layer is determined according to the encoding information of the t-th time video frame in the previous layer and the spatio-temporal feature information at the t-th time in the previous layer, where the spatio-temporal feature information includes the temporal feature information and the spatial feature information at the t-th time in the current layer.

Alternatively, the temporal feature information at the t-th time in the current layer is determined according to the encoding information of the t-th time video frame in the previous layer, the spatio-temporal feature information at the t-th time in the previous layer and the following formula IV

$${M}_{t}^{k} = {M}_{t}^{k - 1} ⊙ {f}_{m} + {l}_{m} \qquad Formula IV$$

$${f}_{m} = σ ( {W}_{z f} * {Z}_{t}^{k - 1} + {W}_{m f} * {M}_{t}^{k - 1} + {b}_{f} )$$

$${l}_{m} = L P B ( {W}_{z m} * {Z}_{t}^{k - 1} + {W}_{m t} * {M}_{t}^{k - 1} + {b}_{m} )$$

$$Where , {M}_{t}^{k}$$

represents the spatio-temporal feature information at the t-th time in the k-th layer, fₘ represents the time feature information at the t-th time in the k−1-th layer, and lₘ represents the spatial feature information at the t-th time in the previous layer.

In S32, the spatio-temporal feature information at the t-th time of the previous layer and the accumulation trend information of the t-th time video frame relative to the first video frame of the current layer are spliced to obtain the fusion feature information.

For instance, the fusion feature information is:

$$[ {T}_{t}^{k} , {M}_{t}^{k} ]$$

In S33, the transient variation information of the t-th time video frame relative to the t−1-th time video frame in the current layer is predicted according to the fusion feature information, the encoding information of the t-th time video frame in the previous layer and the transient variation information of the t−1-th time video frame relative to the t−2-th time video frame in the current layer.

Alternatively, this step is: predicting the transient variation information of the t-th time video frame relative to the t−1-th time video frame in the current layer according to the fusion feature information, the encoding information of the t-th time video frame in the previous layer, the transient variation information of the t−1-th time video frame in the current layer relative to the t−1-th time video frame and the following formula V.

$${V}_{t}^{k} = {o}_{t} ⊙ tanh ( [ {W}_{v t} [ {T}_{t}^{k} , {M}_{t}^{k} ] ) \qquad Formula V$$

$${o}_{t} = σ ( {W}_{z o} * {Z}_{t}^{k - 1} + {W}_{v o} * {V}_{t - 1}^{k} + {W}_{t m} * [ {T}_{t}^{k} , {M}_{t}^{k} ] )$$

It is to be noted that, in the above formula I to formula V,

$${Z}_{t}^{k - 1}$$

represents the feature that the input tensor from the k−1-th layer STACell at the t-th time is encoded into the latent space. Similarly,

$${V}_{t - 1}^{k}$$

$$and$$

$${T}_{t - 1}^{k}$$

represent two spatio-temporal dynamic information of the transient variation information and the accumulation trend information from the k-th layer at the t−1-th time respectively. In addition, the present application may also introduce the spatio-temporal memory flow M state in each layer of STACell. This state follows a zigzag flow, which ensures that the current time step may backtrack to the spatial state of the previous time step, and strengthens a close connection of each time step in the spatio-temporal memory. In this way, the spatio-temporal dynamics of different time steps are no longer isolated.

Where, fₘ and oₜ are two gated tensors for controlling the flow ratio of the information. The roles of these two tensors in STANet are similar to the forget gate and the output gate in LSTM, to control the proportion of the information that is to be selected by subsequent segments before flowing to gating. Moreover,

$$[ {T}_{t}^{k} , {M}_{t}^{k} ]$$

represents splicing the two features in the channel dimension for subsequent feature fusion work. All W. and b. in the above formula represent learnable 2D convolution operators and corresponding bias terms respectively.

To sum up, the MAF Module in STACell organically fuses the transient variation and the accumulation trend through the attention mechanism, so that the spatio-temporal dynamics of these two parts may obtain sufficient information from each other, whilst maintaining respective independence and avoiding mutual pollution and influence between the two spatio-temporal dynamics. In this way, STANet obtains a comprehensive representation combining the transient variation and the accumulation trend. For local temporal and spatial representations, each STACell adaptively selects local temporal and spatial representations and global temporal representations or comprehensive temporal dynamics through a gated tensor, so as to obtain a finally improved spatio-temporal dynamic representation. In addition, a noteworthy phenomenon is that the design of this model allows the transient variation and the accumulation trend to present a dense connection state with corresponding states of all previous historical times. In other words, at the same horizontal layer, the two states of the transient variation V and the accumulation trend T in each STACell unit are densely connected with the states corresponding to all previous STACells in a feed-forward manner on the horizontal layer. Compared with the single recursive connection, this connection method updates the internal state more timely during reverse propagation of the gradient, because each STACell unit may directly obtain the direct gradient information from the loss function for parameter update, which forms a deep supervision mode and at the same time avoids the problem of a vanishing gradient to a certain extent. Furthermore, this method may greatly reduce the iteration times required for training convergence, because the gradient information may keep stable during reverse transmission.

In S203, a t+1-th time video frame of the target video is predicted according to the encoding information of the t-th time video frame and the third video frame information.

In the embodiment of the present disclosure, a ghost effect appears mainly due to the fact that the traditional codec supplements the features lost by a down-sampling operation to the features to be decoded. However, in the same longitudinal loop structure of the recurrent neural network, the video frame to be down-sampled and the video frame to be predicted do not belong to the same time, which leads to the “ghost” effect. This effect is particularly apparent in some scenarios with intense changes in the spatio-temporal dynamics. Therefore, it is necessary to design a suitable module according to the characteristics of this network structure, which may not only supplement the information lost by down-sampling to the decoding end, but also effectively suppress the “ghost” effect produced by the predicted video frame.

As shown in FIG. 3, in order to solve this problem, STANet provides a Context Gated Unit (CGU), which may receive down-sampled features and predicted features concurrently, and adaptively select appropriate features for information supplement by way of the properties of the gated mechanism of the sigmoid function, and suppress irrelevant “ghost” effect.

In some embodiments, this step may include: determining a gated tensor of the encoding information of the t-th time video frame and the transient variation information of the t-th time video frame relative to the t−1-th time video frame according to a difference between the encoding information of the t-th time video frame and the transient variation information of the t-th time video frame relative to the t−1-th time video frame, where the gated tensor is configured to control a proportion of features extracted from the encoding information of the t-th time video frame and the transient variation information of the t-th time video frame relative to the t−1-th time video frame; and predicting a t+1-th time video frame according to the gated tensor, the encoding information of the t-th time video frame and the transient variation information of the t-th time video frame relative to the t−1-th time video frame.

Alternatively, the schematic structural view of the CGU model is shown in FIG. 7. The gated tensor may be presented as Uᵥ and 1−Uᵥ. Accordingly, a gated tensor of the encoding information of the t-th time video frame and the transient variation information of the t-th time video frame relative to the t−1-th time video frame is determined according to a difference between the encoding information of the t-th time video frame, the transient variation information of the t-th time video frame relative to the t−1-th time video frame and the following formula VI; and a t+1-th time video frame is predicted according to the gated tensor, the encoding information of the t-th time video frame, the transient variation information of the t-th time video frame relative to the t−1-th time video frame and the following formula VII.

$${U}_{v} = σ ( \vert {Z}_{t} - {V}_{t}^{m} \vert ) \qquad Formula VI$$

$${\hat{G}}_{t + 1} = {U}_{v} ⊙ {V}_{t}^{m} + ( 1 - {U}_{v} ) ⊙ {Z}_{t} \qquad Formula VII$$

In the above formula VI and formula VII, Uᵥ represents a gated tensor formed by sigmoid. Zₜ is a low-dimensional feature of the latent space obtained by down-sampling the input video frame by the encoder, while Vₜ^{m} represents the feature of the video frame in the latent space predicted by this time step. Inside CGU, these two feature states are first subtracted element by element according to the position relationship, and an absolute value is obtained. For the features thus obtained, the range of all the data points is a distribution from 0 to positive infinity. When the input of the sigmoid function is 0 to positive infinity, its output is between 0.5 and 1.0. Subsequently, the two gated tensors of Uᵥ and (1−Uᵥ) may control the proportion of features extracted from Zₜ and Vₜ^{m} by the finally fused information Ĝₜ₊₁ respectively. This design may allow the model to select necessary information as information supplement according to the importance degree of the two input information at each position, without causing unnecessary “ghost” effect due to excessive extracted information at the same time.

The embodiment of the present disclosure provides a video frame prediction method. The method includes: obtaining first video frame information and second video frame information of a target video to be predicted, where the first video frame information includes the accumulation trend information of each historical video frame relative to a first video frame and the transient variation information of each historical video frame relative to a last time video frame of the historical video frame, the historical video frame includes a second time video frame to a t−1-th time video frame of the target video, and the second video frame information includes encoding information of a t-th time video frame of the target video; where the t-th time is a current time and t is a positive integer; predicting third video frame information of the t-th time video frame according to the first video frame information, the second video frame information and a video frame prediction model, where the third video frame information includes the accumulation trend information of the t-th time video frame relative to the first video frame and the transient variation information of the t-th time video frame relative to the t−1-th time video frame; and predicting a t+1-th time video frame of the target video according to the encoding information of the t-th time video frame and the third video frame information. In this technical solution, since the video frame prediction model combines the two spatio-temporal dynamics of the transient variation information and the accumulation trend information implicated in the video frame sequence, the two spatio-temporal dynamics may not only supervise respective synthesis processes for each other, but also provide necessary information supplements for each other, thereby improving the accuracy of predicting a video frame. Moreover, when the t+1-th time video frame is predicted, the encoding information of the t-th time video frame is combined with the transient variation information of the t-th time video frame relative to the last time video frame, which may avoid apparent spatial position deviation, thereby further improving the accuracy of predicting a video frame.

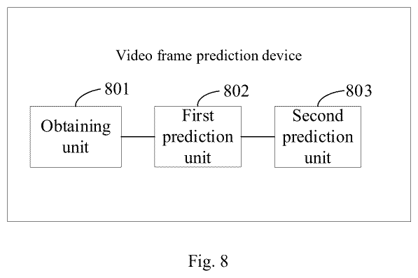

FIG. 8 is a schematic structural view of a video frame prediction device provided by the embodiment of the present disclosure. As shown in FIG. 8, the video frame prediction device includes:
an obtaining unit 801 configured to obtain first video frame information and second video frame information of a target video to be predicted, where the first video frame information includes accumulation trend information of each historical video frame relative to a first video frame and transient variation information of each historical video frame relative to a last time video frame of the historical video frame, the historical video frame includes a second time video frame to a t−1-th time video frame of the target video, and the second video frame information includes encoding information of a t-th time video frame of the target video; where the t-th time is a current time and t is a positive integer;
a first prediction unit 802 configured to predict third video frame information of the t-th time video frame according to the first video frame information, the second video frame information and a video frame prediction model, where the third video frame information includes accumulation trend information of the t-th time video frame relative to the first video frame and transient variation information of the t-th time video frame relative to the t−1-th time video frame; and
a second prediction unit 803 configured to predict a t+1-th time video frame of the target video according to the encoding information of the t-th time video frame and the third video frame information.

According to one or more embodiments of the present disclosure, the video frame prediction model includes multiple layers of spatio-temporal attention cells arranged longitudinally. Accordingly, the first prediction unit 802 predicting the third video frame information of the t-th time video frame according to the first video frame information, the second video frame information and a video frame prediction model includes: for each layer of spatio-temporal attention cell, predicting the accumulation trend information of the t-th time video frame relative to the first video frame of the current layer and the transient variation information of the t-th time video frame relative to the t−1-th time video frame of the current layer according to a multi-scale attention fusion MAF model of the layer of spatio-temporal attention cell, the accumulation trend information of each historical video frame relative to the first video frame in the current layer, the transient variation information of each historical video frame relative to a last time video frame of the historical video frame in the current layer and the encoding information of the t-th time video frame of the target video in the previous layer; and determining the accumulation trend information of the t-th time video frame relative to the first video frame of the last layer as the accumulation trend information of the t-th time video frame relative to the first video frame, and determining the transient variation information of the t-th time video frame relative to the t−1-th time video frame of the last layer as the transient variation information of the t-th time video frame relative to the t−1-th time video frame.

According to one or more embodiments of the present disclosure, the first prediction unit 802 predicting the accumulation trend information of the t-th time video frame relative to the first video frame of the current layer and the transient variation information of the t-th time video frame of the current layer the t−1-th time video frame according to a multi-scale attention fusion MAF model of the layer of spatio-temporal attention cell, the accumulation trend information of each historical video frame relative to the first video frame in the current layer, the transient variation information of each historical video frame relative to a last time video frame of the historical video frame in the current layer and the encoding information of the t-th time video frame of the target video in the previous layer includes: according to the multi-scale attention fusion MAF model, fusing the accumulation trend information of each historical video frame relative to the first video frame in the current layer and the transient variation information of each historical video frame relative to a last time video frame of the historical video frame in the current layer to determine first variation information of the t-th time video frame in the current layer in the time dimension; and determining second variation information of the t-th time video frame in the current layer in the spatial dimension according to the encoding information of the t-th time video frame in the previous layer and the transient variation information of the t−1-th time video frame relative to the t−2-th time video frame in the current layer; predicting the accumulation trend information of the t-th time video frame relative to the first video frame of the current layer according to the first variation information, the second variation information and the accumulation trend information of the t−1-th time video frame relative to the first video frame of the current layer; and predicting the transient variation information of the t-th time video frame relative to the t−1-th time video frame of the current layer according to the accumulation trend information of the t-th time video frame relative to the first video frame of the current layer.

According to one or more embodiments of the present disclosure, the first prediction unit 802, according to the multi-scale attention fusion MAF model, fusing the accumulation trend information of each historical video frame relative to the first video frame in the current layer and the transient variation information of each historical video frame relative to a last time video frame of the historical video frame in the current layer to determine the first variation information of the t-th time video frame in the current layer in the time dimension includes: determining an attention weight of each historical video frame in the current layer according to the transient variation information of each historical video frame relative to a last time video frame of the historical video frame in the current layer; according to the attention weight of each historical video frame in the current layer, aggregating the accumulation trend information of the video frame at each historical time relative to the first video frame in the current layer in the time dimension, to determine a global motion trend of the t−1-th time video frame in the current layer in the time dimension; and combining the global motion trend of the t−1-th time video frame in the current layer and the accumulation trend information of the t−1-th time video frame relative to the first video frame in the current layer to determine the first variation information of the t-th time video frame in the current layer in the time dimension.

According to one or more embodiments of the present disclosure, the first prediction unit 802 determining the second variation information of the t-th time video frame in the current layer in the spatial dimension according to the encoding information of the t-th time video frame in the previous layer and the transient variation information of the t−1-th time video frame relative to the t−2-th time video frame in the current layer includes: determining a first convolution operator corresponding to the encoding information of the t-th time video frame in the previous layer and a second convolution operator corresponding to the transient variation information of the t−1-th time video frame relative to the t−2-th time video frame in the current layer; and determining the second variation information of the t-th time video frame in the current layer in the spatial dimension according to a product of the encoding information of the t-th time video frame in the previous layer and the first convolution operator, a product of the transient variation information of the t−1-th time video frame relative to the t−2-th time video frame in the current layer and a local spatial information calculation model.

According to one or more embodiments of the present disclosure, the first prediction unit 802 predicting the accumulation trend information of the t-th time video frame relative to the first video frame of the current layer according to the first variation information, the second variation information and the accumulation trend information of the t−1-th time video frame relative to the first video frame of the current layer includes: performing dot product operation on the accumulation trend information of the t−1-th time video frame relative to the first video frame of the current layer and the first variation information to obtain a first vector information; and predicting the accumulation trend information of the t-th time video frame relative to the first video frame of the current layer according to a sum of the first vector information and the second variation information.

According to one or more embodiments of the present disclosure, the first prediction unit 802 predicting the transient variation information of the t-th time video frame relative to the t−1-th time video frame of the current layer according to the accumulation trend information of the t-th time video frame relative to the first video frame of the current layer includes: determining the spatio-temporal feature information at the t-th time in the previous layer according to the encoding information of the t-th time video frame in the previous layer, where the spatio-temporal feature information includes the temporal feature information and the spatial feature information at the t-th time in the previous layer; splicing the spatio-temporal feature information at the t-th time of the previous layer and the accumulation trend information of the t-th time video frame relative to the first video frame of the current layer to obtain the fusion feature information; and predicting the transient variation information of the t-th time video frame relative to the t−1-th time video frame in the current layer according to the fusion feature information, the encoding information of the t-th time video frame in the previous layer and the transient variation information of the t−1-th time video frame relative to the t−2-th time video frame in the current layer.

According to one or more embodiments of the present disclosure, the second prediction unit 803 predicting a t+1-th time video frame of the target video according to the encoding information of the t-th time video frame and the third video frame information includes: determining a gated tensor of the encoding information of the t-th time video frame and the transient variation information of the t-th time video frame relative to the t−1-th time video frame according to a difference between the encoding information of the t-th time video frame and the transient variation information of the t-th time video frame relative to the t−1-th time video frame, where the gated tensor is configured to control a proportion of features extracted from the encoding information of the t-th time video frame and the transient variation information of the t-th time video frame relative to the t−1-th time video frame; and predicting a t+1-th time video frame of the target video according to the gated tensor, the encoding information of the t-th time video frame and the transient variation information of the t-th time video frame relative to the t−1-th time video frame.

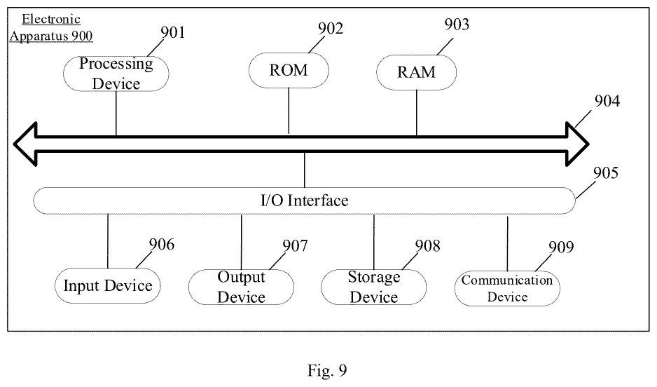

Referring to FIG. 9, which shows a structural schematic view of an electronic device 900 suitable for implementing the embodiment of the present disclosure, the electronic device 900 may be a terminal device or a server. Where, the terminal device may include, but is not limited to, a mobile terminal such as a mobile phone, a notebook computer, a digital broadcast receiver, a Personal Digital Assistant (referred to as PDA for short), Tablet Computer (PAD), a Portable Multimedia Player (referred to as PMP for short) and a vehicle-mounted terminal (for example, a vehicle-mounted navigation terminal); and a fixed terminal such as a digital TV and a desktop computer. The electronic device shown in FIG. 9 which is only an example, shall not limit the functions and application range of the embodiments of the present disclosure.

As shown in FIG. 9, the electronic device 900 may include a processing device (for example, a central processing unit, a graphic processor, and the like) 901, which may perform various appropriate actions and processing according to a program stored in a Read-only Memory (referred to as ROM for short) 902 or a program loaded from a storage means 908 into a Random Access Memory (referred to as RAM for short) 903. In the RAM 903, various programs and data required for the operation of the electronic device 900 are also stored. The processing device 901, the ROM 902 and the RAM 903 are connected to each other through a bus 904. The input/output (I/O) interface 905 is also connected to the bus 904.

Generally, the following devices may be connected to the I/O interface 905: an input means 906 including, for example, a touch screen, a touch pad, a keyboard, a mouse, a camera, a microphone, an accelerometer, a gyroscope, and the like; an output means 907 including, for example, a Liquid Crystal Display (referred to as LCD for short), a speaker, a vibrator, and the like; a storage means 908 including, for example, a magnetic tape, a hard disk, and the like; and a communication means 909. The communication means 909 may allow the electronic device 900 to be in wireless or wired communication with other devices to exchange data. Although FIG. 9 shows the electronic device 900 with various devices, it should be understood that it is not required to implement or possess all the devices shown. It is possible to alternatively implement or possess more or less devices.

In particular, according to the embodiment of the present disclosure, the process described above with reference to the flowchart may be implemented as a computer software program. For example, the embodiment of the present disclosure includes a computer program product including a computer program carried on a computer-readable medium, where the computer program contains program codes for performing the method shown in the flowchart. In such embodiment, the computer program may be downloaded and installed from the network through the communication means 909, installed from the storage means 908, or installed from the ROM 902. When the computer program is executed by the processing device 901, the above functions defined in the method of the embodiment of the present disclosure are performed.

It is to be noted that, the above computer-readable medium of the present disclosure may be a computer-readable signal medium, a computer-readable storage medium or any combination thereof. The computer-readable storage medium may be, for example, but is not limited to: an electrical, magnetic, optical, electromagnetic, infrared, or semiconductor system, device, or apparatus, or a combination thereof. More specific examples of the computer-readable storage medium may include, but are not limited to: an electrical connection having one or more wires, a portable computer disk, a hard disk, a random access memory (RAM), a read-only memory (ROM), an erasable programmable read-only memory (EPROM or flash memory), an optical fiber, a portable compact disk read-only memory (CD-ROM), an optical storage means, a magnetic storage means, or any suitable combination thereof. In the present disclosure, a computer-readable storage medium may be any tangible medium that contains or stores a program which may be used by an instruction execution system, apparatus, or device or used in combination therewith. In the present disclosure, the computer-readable signal medium may include a data signal propagated in a baseband or as a part of a carrier wave, where a computer-readable program code is carried. Such propagated data signal may take many forms, including but not limited to an electromagnetic signal, an optical signal, or any suitable combination thereof. The computer-readable signal medium may also be any computer-readable medium other than the computer-readable storage medium. The computer-readable signal medium may send, propagate, or transmit a program for use by an instruction execution system, apparatus, or device or in combination therewith. The program code contained on the computer-readable medium may be transmitted by any suitable medium, including but not limited to: a wire, an optical cable, radio frequency (RF), and the like, or any suitable combination thereof.

The above computer-readable medium may be included in the above electronic device; or may also exist alone without being assembled into the electronic device.

The above computer-readable medium carries one or more programs, that, when executed by the electronic device, cause the electronic device to: perform the method shown in the above embodiments.

The computer program code for performing the operations of the present disclosure may be written in one or more programming languages or a combination thereof. The above programming languages include object-oriented programming languages, such as Java, Smalltalk, and C++, and also include conventional procedural programming languages, such as “C” language or similar programming languages. The program code may be executed entirely on the user's computer, partly on the user's computer, executed as an independent software package, partly on the user's computer and partly executed on a remote computer, or entirely executed on the remote computer or server. In the case of a remote computer, the remote computer may be connected to the user's computer through any kind of network (including a local area network (referred to as LAN for short) or a wide area network (referred to as WAN for short)), or may be connected to an external computer (for example, connected through Internet using an Internet service provider).

The flowcharts and block views in the accompanying drawings illustrate the possibly implemented architectures, functions, and operations of the system, method, and computer program product according to various embodiments of the present disclosure. In this regard, each block in the flowchart or block view may represent a module, a program segment, or a part of code, where the module, the program segment, or the part of code contains one or more executable instructions for realizing a specified logic function. It should also be noted that, in some alternative implementations, the functions marked in the block may also occur in a different order from the order marked in the accompanying drawings. For example, two blocks shown in succession which may actually be executed substantially in parallel, may sometimes also be executed in a reverse order, depending on the functions involved. It is also to be noted that each block in the block view and/or flowchart, and a combination of the blocks in the block view and/or flowchart, may be implemented by a dedicated hardware-based system that performs the specified functions or operations, or may be implemented by a combination of dedicated hardware and computer instructions.

The units involved in the described embodiments of the present disclosure may be implemented in software or hardware. Where, the name of the unit does not constitute a delimitation on the unit itself in a certain circumstance. For example, the first obtaining unit may also be described as “a unit for obtaining at least two internet protocol addresses”.

The functions described hereinabove may be performed at least in part by one or more hardware logic components. For example, without limitation, the hardware logic components of a demonstrative type that may be used include: a Field Programmable Gate Array (FPGA), an Application Specific Integrated Circuit (ASIC), an Application Specific Standard Product (ASSP), a System on Chip (SOC), a Complex Programmable Logical device (CPLD) and the like.

In a first aspect, according to one or more embodiments of the present disclosure, a video frame prediction method is provided. The method includes:
obtaining first video frame information and second video frame information of a target video to be predicted, where the first video frame information includes the accumulation trend information of each historical video frame relative to a first video frame and transient variation information of each historical video frame relative to a last time video frame of the historical video frame, the historical video frame includes a second time video frame to a t−1-th time video frame of the target video, and the second video frame information includes encoding information of a t-th time video frame of the target video; where the t-th time is a current time and t is a positive integer;
predicting third video frame information of the t-th time video frame according to the first video frame information, the second video frame information and a video frame prediction model, where the third video frame information includes the accumulation trend information of the t-th time video frame relative to the first video frame and the transient variation information of the t-th time video frame relative to the t−1-th time video frame; and
predicting a t+1-th time video frame of the target video according to the encoding information of the t-th time video frame and the third video frame information.

According to one or more embodiments of the present disclosure, the video frame prediction model includes multiple layers of spatio-temporal attention cells arranged longitudinally. Accordingly, the predicting third video frame information of the t-th time video frame according to the first video frame information, the second video frame information and a video frame prediction model includes: for each layer of spatio-temporal attention cell, predicting accumulation trend information of the t-th time video frame relative to the first video frame of the current layer and transient variation information of the t-th time video frame relative to the t−1-th time video frame of the current layer according to a multi-scale attention fusion MAF model of the layer of spatio-temporal attention cell, the accumulation trend information of each historical video frame relative to the first video frame in the current layer, the transient variation information of each historical video frame relative to a last time video frame of the historical video frame in the current layer and the encoding information of the t-th time video frame of the target video in the previous layer; and determining the accumulation trend information of the t-th time video frame relative to the first video frame of the last layer as the accumulation trend information of the t-th time video frame relative to the first video frame, and determining the transient variation information of the t-th time video frame relative to the t−1-th time video frame of the last layer as the transient variation information of the t-th time video frame relative to the t−1-th time video frame.

According to one or more embodiments of the present disclosure, the predicting the accumulation trend information of the t-th time video frame relative to the first video frame of the current layer and the transient variation information of the t-th time video frame of the current layer the t−1-th time video frame according to the multi-scale attention fusion MAF model of the layer of spatio-temporal attention cell, the accumulation trend information of each historical video frame relative to the first video frame in the current layer, the transient variation information of each historical video frame relative to a last time video frame of the historical video frame in the current layer and the encoding information of the t-th time video frame of the target video in the previous layer includes: according to the multi-scale attention fusion MAF model, fusing the accumulation trend information of each historical video frame relative to the first video frame in the current layer and the transient variation information of each historical video frame relative to a last time video frame of the historical video frame in the current layer, to determine first variation information of the t-th time video frame in the current layer in the time dimension; and determining second variation information of the t-th time video frame in the current layer in the spatial dimension according to the encoding information of the t-th time video frame in the previous layer and the transient variation information of the t−1-th time video frame relative to the t−2-th time video frame in the current layer; predicting the accumulation trend information of the t-th time video frame relative to the first video frame of the current layer according to the first variation information, the second variation information and the accumulation trend information of the t−1-th time video frame relative to the first video frame of the current layer; and predicting the transient variation information of the t-th time video frame relative to the t−1-th time video frame of the current layer according to the accumulation trend information of the t-th time video frame relative to the first video frame of the current layer.

According to one or more embodiments of the present disclosure, the according to the multi-scale attention fusion MAF model, fusing the accumulation trend information of each historical video frame relative to the first video frame in the current layer and the transient variation information of each historical video frame relative to a last time video frame of the historical video frame in the current layer to determine the first variation information of the t-th time video frame in the current layer in the time dimension includes: determining an attention weight of each historical video frame in the current layer according to the transient variation information of each historical video frame relative to a last time video frame of the historical video frame in the current layer; according to the attention weight of each historical video frame in the current layer, aggregating the accumulation trend information of the video frame at each historical time relative to the first video frame in the current layer in the time dimension, to determine a global motion trend of the t−1-th time video frame in the current layer in the time dimension; and combining the global motion trend of the t−1-th time video frame in the current layer in the time dimension and the accumulation trend information of the t−1-th time video frame relative to the first video frame in the current layer to determine the first variation information of the t-th time video frame in the current layer in the time dimension.

According to one or more embodiments of the present disclosure, the determining the second variation information of the t-th time video frame in the current layer in the spatial dimension according to the encoding information of the t-th time video frame in the previous layer and the transient variation information of the t−1-th time video frame relative to the t−2-th time video frame in the current layer includes: determining a first convolution operator corresponding to the encoding information of the t-th time video frame in the previous layer and a second convolution operator corresponding to the transient variation information of the t−1-th time video frame relative to the t−2-th time video frame in the current layer; and determining the second variation information of the t-th time video frame in the current layer in the spatial dimension according to a product of the encoding information of the t-th time video frame in the previous layer and the first convolution operator, a product of the transient variation information of the t−1-th time video frame relative to the t−2-th time video frame in the current layer and a local spatial information calculation model.

According to one or more embodiments of the present disclosure, the predicting the accumulation trend information of the t-th time video frame relative to the first video frame of the current layer according to the first variation information, the second variation information and the accumulation trend information of the t−1-th time video frame relative to the first video frame of the current layer includes: performing dot product operation on the accumulation trend information of the t−1-th time video frame relative to the first video frame of the current layer and the first variation information to obtain first vector information; and predicting the accumulation trend information of the t-th time video frame relative to the first video frame of the current layer according to a sum of the first vector information and the second variation information.

According to one or more embodiments of the present disclosure, the predicting the transient variation information of the t-th time video frame relative to the t−1-th time video frame of the current layer according to the accumulation trend information of the t-th time video frame relative to the first video frame of the current layer includes: determining the spatio-temporal feature information at the t-th time in the previous layer according to the encoding information of the t-th time video frame in the previous layer, where the spatio-temporal feature information includes the temporal feature information and the spatial feature information at the t-th time in the previous layer; splicing the spatio-temporal feature information at the t-th time of the previous layer and the accumulation trend information of the t-th time video frame relative to the first video frame of the current layer to obtain the fusion feature information; and predicting the transient variation information of the t-th time video frame relative to the t−1-th time video frame in the current layer according to the fusion feature information, the encoding information of the t-th time video frame in the previous layer and the transient variation information of the t−1-th time video frame relative to the t−2-th time video frame in the current layer.

According to one or more embodiments of the present disclosure, the predicting a t+1-th time video frame of the target video according to the encoding information of the t-th time video frame and the third video frame information includes: determining a gated tensor of the encoding information of the t-th time video frame and the transient variation information of the t-th time video frame relative to the t−1-th time video frame according to a difference between the encoding information of the t-th time video frame and the transient variation information of the t-th time video frame relative to the t−1-th time video frame, where the gated tensor is configured to control a proportion of features extracted from the encoding information of the t-th time video frame and the transient variation information of the t-th time video frame relative to the t−1-th time video frame; and predicting the t+1-th time video frame of the target video according to the gated tensor, the encoding information of the t-th time video frame and the transient variation information of the t-th time video frame relative to the t−1-th time video frame.

In a second aspect, according to one or more embodiments of the present disclosure, a video frame prediction device is provided. The device includes:
an obtaining unit configured to obtain first video frame information and second video frame information of a target video to be predicted, where the first video frame information includes the accumulation trend information of each historical video frame relative to a first video frame and transient variation information of each historical video frame relative to a last time video frame of the historical video frame, the historical video frame includes a second time video frame to a t−1-th time video frame of the target video, and the second video frame information includes encoding information of a t-th time video frame of the target video; where the t-th time is a current time and t is a positive integer;
a first prediction unit configured to predict the third video frame information of the t-th time video frame according to the first video frame information, the second video frame information and a video frame prediction model, where the third video frame information includes the accumulation trend information of the t-th time video frame relative to the first video frame and the transient variation information of the t-th time video frame relative to the t−1-th time video frame; and
a second prediction unit configured to predict a t+1-th time video frame of the target video according to the encoding information of the t-th time video frame and the third video frame information.

According to one or more embodiments of the present disclosure, the video frame prediction model includes multiple layers of spatio-temporal attention cells arranged longitudinally. Accordingly, the first prediction unit predicting the third video frame information of the t-th time video frame according to the first video frame information, the second video frame information and a video frame prediction model includes: for each layer of spatio-temporal attention cell, predicting the accumulation trend information of the t-th time video frame relative to the first video frame of the current layer and the transient variation information of the t-th time video frame relative to the t−1-th time video frame of the current layer according to a multi-scale attention fusion MAF model of the layer of spatio-temporal attention cell, the accumulation trend information of each historical video frame relative to the first video frame in the current layer, the transient variation information of each historical video frame relative to a last time video frame of the historical video frame in the current layer and the encoding information of the t-th time video frame of the target video in the previous layer; and determining the accumulation trend information of the t-th time video frame relative to the first video frame of the last layer as the accumulation trend information of the t-th time video frame relative to the first video frame, and determining the transient variation information of the t-th time video frame relative to the t−1-th time video frame of the last layer as the transient variation information of the t-th time video frame relative to the t−1-th time video frame.

According to one or more embodiments of the present disclosure, the first prediction unit predicting the accumulation trend information of the t-th time video frame relative to the first video frame of the current layer and the transient variation information of the t-th time video frame of the current layer the t−1-th time video frame according to a multi-scale attention fusion MAF model of the layer of spatio-temporal attention cell, the accumulation trend information of each historical video frame relative to the first video frame in the current layer, the transient variation information of each historical video frame relative to a last time video frame of the historical video frame in the current layer and the encoding information of the t-th time video frame of the target video in the previous layer includes: according to the multi-scale attention fusion MAF model, fusing the accumulation trend information of each historical video frame relative to the first video frame in the current layer and the transient variation information of each historical video frame relative to a last time video frame of the historical video frame in the current layer to determine first variation information of the t-th time video frame in the current layer in the time dimension; and determining second variation information of the t-th time video frame in the current layer in the spatial dimension according to the encoding information of the t-th time video frame in the previous layer and the transient variation information of the t−1-th time video frame relative to the t−2-th time video frame in the current layer; predicting the accumulation trend information of the t-th time video frame relative to the first video frame of the current layer according to the first variation information, the second variation information and the accumulation trend information of the t−1-th time video frame relative to the first video frame of the current layer; and predicting the transient variation information of the t-th time video frame relative to the t−1-th time video frame of the current layer according to the accumulation trend information of the t-th time video frame relative to the first video frame of the current layer.

According to one or more embodiments of the present disclosure, the first prediction unit, according to the multi-scale attention fusion MAF model, fusing the accumulation trend information of each historical video frame relative to the first video frame in the current layer and the transient variation information of each historical video frame relative to a last time video frame of the historical video frame in the current layer to determine the first variation information of the t-th time video frame in the current layer in the time dimension includes: determining an attention weight of each historical video frame in the current layer according to the transient variation information of each historical video frame relative to a last time video frame of the historical video frame in the current layer; according to the attention weight of each historical video frame in the current layer, aggregating the accumulation trend information of the video frame at each historical time relative to the first video frame in the current layer in the time dimension, to determine a global motion trend of the t−1-th time video frame in the current layer in the time dimension; and combining the global motion trend of the t−1-th time video frame in the current layer and the accumulation trend information of the t−1-th time video frame relative to the first video frame in the current layer to determine the first variation information of the t-th time video frame in the current layer in the time dimension.

According to one or more embodiments of the present disclosure, the first prediction unit determining the second variation information of the t-th time video frame in the current layer in the spatial dimension according to the encoding information of the t-th time video frame in the previous layer and the transient variation information of the t−1-th time video frame relative to the t−2-th time video frame in the current layer includes: determining a first convolution operator corresponding to the encoding information of the t-th time video frame in the previous layer and a second convolution operator corresponding to the transient variation information of the t−1-th time video frame relative to the t−2-th time video frame in the current layer; and determining the second variation information of the t-th time video frame in the current layer in the spatial dimension according to a product of the encoding information of the t-th time video frame in the previous layer and the first convolution operator, a product of the transient variation information of the t−1-th time video frame relative to the t−2-th time video frame in the current layer and the second convolution operator, and a local spatial information calculation model.

According to one or more embodiments of the present disclosure, the first prediction unit predicting the accumulation trend information of the t-th time video frame relative to the first video frame of the current layer according to the first variation information, the second variation information and the accumulation trend information of the t−1-th time video frame relative to the first video frame of the current layer includes: performing dot product operation on the accumulation trend information of the t−1-th time video frame relative to the first video frame of the current layer and the first variation information to obtain the first vector information; and predicting the accumulation trend information of the t-th time video frame relative to the first video frame of the current layer according to a sum of the first vector information and the second variation information.

According to one or more embodiments of the present disclosure, the first prediction unit predicting the transient variation information of the t-th time video frame relative to the t−1-th time video frame of the current layer according to the accumulation trend information of the t-th time video frame relative to the first video frame of the current layer includes: determining the spatio-temporal feature information at the t-th time in the previous layer according to the encoding information of the t-th time video frame in the previous layer, where the spatio-temporal feature information includes the temporal feature information and the spatial feature information at the t-th time in the previous layer; splicing the spatio-temporal feature information at the t-th time of the previous layer and the accumulation trend information of the t-th time video frame relative to the first video frame of the current layer to obtain the fusion feature information; and predicting the transient variation information of the t-th time video frame relative to the t−1-th time video frame in the current layer according to the fusion feature information, the encoding information of the t-th time video frame in the previous layer and the transient variation information of the t−1-th time video frame relative to the t−2-th time video frame in the current layer.

According to one or more embodiments of the present disclosure, the second prediction unit predicting the t+1-th time video frame of the target video according to the encoding information of the t-th time video frame and the third video frame information includes: determining a gated tensor of the encoding information of the t-th time video frame and the transient variation information of the t-th time video frame relative to the t−1-th time video frame according to a difference between the encoding information of the t-th time video frame and the transient variation information of the t-th time video frame relative to the t−1-th time video frame, where the gated tensor is configured to control a proportion of features extracted from the encoding information of the t-th time video frame and the transient variation information of the t-th time video frame relative to the t−1-th time video frame; and predicting the t+1-th time video frame of the target video according to the gated tensor, the encoding information of the t-th time video frame and the transient variation information of the t-th time video frame relative to the t−1-th time video frame.

In a third aspect, according to one or more embodiments of the present disclosure, an electronic device is provided. The electronic device includes: at least one processor and a memory;
where the memory stores computer-executable instructions; and
the at least one processor executes the computer-executable instructions stored in the memory, so that the at least one processor performs the video frame prediction method as described above in the first aspect and various possible designs of the first aspect.

In a fourth aspect, according to one or more embodiments of the present disclosure, a computer-readable storage medium is provided. The computer-readable storage medium has computer-executable instructions stored thereon that, when executed by a processor, implement the video frame prediction method as described above in the first aspect and various possible designs of the first aspect.

In a fifth aspect, according to one or more embodiments of the present disclosure, a computer program product is provided. The computer program product includes a computer program that, when executed by a processor, implements the video frame prediction method as described above in the first aspect and various possible designs of the first aspect.

The above description is only an explanation of preferred embodiments of the present disclosure and the applied technical principles. Those skilled in the art should understand that the scope of disclosure involved in this disclosure is not limited to the technical solutions formed by the specific combination of the above technical features, and at the same time should also cover other technical solutions formed by arbitrarily combining the above technical features or equivalent features without departing from the above disclosed concept. For example, the above features and the technical features disclosed in the present disclosure (but not limited thereto) having similar functions are replaced with each other to form a technical solution.

In addition, although the operations are depicted in a specific order, this should not be understood as requiring these operations to be performed in the specific order shown or performed in a sequential order. Under certain circumstances, multitasking and parallel processing might be advantageous. Likewise, although several specific implementation details are contained in the above discussion, these should not be construed as limiting the scope of the present disclosure. Certain features that are described in the context of individual embodiments may also be implemented in combination in a single embodiment. On the contrary, various features described in the context of a single embodiment may also be implemented in multiple embodiments individually or in any suitable sub-combination.

Although the present subject matter has been described in language specific to structural features and/or methodological actions, it should be understood that the subject matter defined in the appended claims is not necessarily limited to the specific features or actions described above. On the contrary, the specific features and actions described above are only exemplary forms of implementing the claims.

What is claimed is:

1. A video frame prediction method, comprising:
obtaining first video frame information and second video frame information of a target video to be predicted, wherein the first video frame information comprises accumulation trend information of each historical video frame relative to a first video frame and transient variation information of each historical video frame relative to a last time video frame of the historical video frame, the historical video frame comprises a second time video frame to a t−1-th time video frame of the target video, and the second video frame information comprises encoding information of a t-th time video frame of the target video; wherein the t-th time is a current time and t is a positive integer;
predicting third video frame information of the t-th time video frame according to the first video frame information, the second video frame information and a video frame prediction model, wherein the third video frame information comprises accumulation trend information of the t-th time video frame relative to the first video frame and the transient variation information of the t-th time video frame relative to the t−1-th time video frame;
predicting a t+1-th time video frame of the target video according to the encoding information of the t-th time video frame and the third video frame information.

2. The method according to claim 1, wherein the video frame prediction model comprises multiple layers of spatio-temporal attention cells arranged longitudinally;
correspondingly, the predicting the third video frame information of the t-th time video frame according to the first video frame information, the second video frame information and the video frame prediction model comprises:
for each layer of spatio-temporal attention cell, predicting the accumulation trend information of the t-th time video frame relative to the first video frame of the current layer and the transient variation information of the t-th time video frame relative to the t−1-th time video frame of the current layer according to a multi-scale attention fusion MAF model of the layer of spatio-temporal attention cell, the accumulation trend information of each historical video frame relative to the first video frame in the current layer, the transient variation information of each historical video frame relative to the last time video frame of the historical video frame in the current layer and encoding information of the t-th time video frame of the target video in the previous layer;
determining the accumulation trend information of the t-th time video frame relative to the first video frame of the last layer as the accumulation trend information of the t-th time video frame relative to the first video frame, and determining the transient variation information of the t-th time video frame relative to the t−1-th time video frame of the last layer as the transient variation information of the t-th time video frame relative to the t−1-th time video frame.

3. The method according to claim 2, wherein the predicting the accumulation trend information of the t-th time video frame relative to the first video frame of the current layer and the transient variation information of the t-th time video frame relative to the t−1-th time video frame of the current layer according to the multi-scale attention fusion MAF model of the layer of spatio-temporal attention cell, the accumulation trend information of each historical video frame relative to the first video frame in the current layer, the transient variation information of each historical video frame relative to the last time video frame of the historical video frame in the current layer and the encoding information of the t-th time video frame of the target video in the previous layer comprises:
according to the multi-scale attention fusion MAF model, fusing the accumulation trend information of each historical video frame relative to the first video frame in the current layer and the transient variation information of each historical video frame relative to the last time video frame of the historical video frame in the current layer to determine first variation information of the t-th time video frame in the current layer in the time dimension; and determining second variation information of the t-th time video frame in the current layer in the spatial dimension according to the encoding information of the t-th time video frame in the previous layer and the transient variation information of the t−1-th time video frame relative to the t−2-th time video frame in the current layer;
predicting the accumulation trend information of the t-th time video frame relative to the first video frame of the current layer according to the first variation information, the second variation information and the accumulation trend information of the t−1-th time video frame relative to the first video frame of the current layer;
predicting the transient variation information of the t-th time video frame relative to the t−1-th time video frame of the current layer according to the accumulation trend information of the t-th time video frame relative to the first video frame of the current layer.

4. The method according to claim 3, wherein the according to the multi-scale attention fusion MAF model, fusing the accumulation trend information of each historical video frame relative to the first video frame in the current layer and the transient variation information of each historical video frame relative to the last time video frame of the historical video frame in the current layer to determine the first variation information of the t-th time video frame in the current layer in the time dimension comprises:
determining an attention weight of each historical video frame in the current layer according to the transient variation information of each historical video frame relative to the last time video frame of the historical video frame in the current layer;
according to the attention weight of each historical video frame in the current layer, aggregating the accumulation trend information of the video frame at each historical time relative to the first video frame in the current layer in the time dimension, to determine a global motion trend of the t−1-th time video frame in the current layer in the time dimension;
combining the global motion trend of the t−1-th time video frame in the current layer in the time dimension and the accumulation trend information of the t−1-th time video frame relative to the first video frame in the current layer to determine the first variation information of the t-th time video frame in the current layer in the time dimension.

5. The method according to claim 3, wherein the determining the second variation information of the t-th time video frame in the current layer in the spatial dimension according to the encoding information of the t-th time video frame in the previous layer and the transient variation information of the t−1-th time video frame relative to the t−2-th time video frame in the current layer comprises:
determining a first convolution operator corresponding to the encoding information of the t-th time video frame in the previous layer and a second convolution operator corresponding to the transient variation information of the t−1-th time video frame relative to the t−2-th time video frame in the current layer;
determining the second variation information of the t-th time video frame in the current layer in the spatial dimension according to a product of the encoding information of the t-th time video frame in the previous layer and the first convolution operator, a product of the transient variation information of the t−1-th time video frame relative to the t−2-th time video frame in the current layer and second convolution operator, and a local spatial information calculation model.

6. The method according to claim 3, wherein the predicting the accumulation trend information of the t-th time video frame relative to the first video frame of the current layer according to the first variation information, the second variation information and the accumulation trend information of the t−1-th time video frame relative to the first video frame of the current layer comprises:
performing dot product operation on the accumulation trend information of the t−1-th time video frame relative to the first video frame of the current layer and the first variation information to obtain first vector information;
predicting the accumulation trend information of the t-th time video frame relative to the first video frame of the current layer according to a sum of the first vector information and the second variation information.

7. The method according to claim 3, wherein the predicting the transient variation information of the t-th time video frame relative to the t−1-th time video frame of the current layer according to the accumulation trend information of the t-th time video frame relative to the first video frame of the current layer comprises:
determining spatio-temporal feature information at the t-th time in the previous layer according to the encoding information of the t-th time video frame in the previous layer, wherein the spatio-temporal feature information comprises temporal feature information and spatial feature information at the t-th time in the previous layer;
splicing the spatio-temporal feature information at the t-th time in the previous layer and the accumulation trend information of the t-th time video frame relative to the first video frame of the current layer to obtain fusion feature information;
predicting the transient variation information of the t-th time video frame relative to the t−1-th time video frame in the current layer according to the fusion feature information, the encoding information of the t-th time video frame in the previous layer and the transient variation information of the t−1-th time video frame relative to the t−2-th time video frame in the current layer.

8. The method according to claim 1, wherein the predicting the t+1-th time video frame of the target video according to the encoding information of the t-th time video frame and the third video frame information comprises:
determining a gated tensor of the encoding information of the t-th time video frame and the transient variation information of the t-th time video frame relative to the t−1-th time video frame according to a difference between the encoding information of the t-th time video frame and the transient variation information of the t-th time video frame relative to the t−1-th time video frame, wherein the gated tensor is configured to control a proportion of features extracted from the encoding information of the t-th time video frame and the transient variation information of the t-th time video frame relative to the t−1-th time video frame;
predicting the t+1-th time video frame of the target video according to the gated tensor, the encoding information of the t-th time video frame and the transient variation information of the t-th time video frame relative to the t−1-th time video frame.

9. An electronic device, comprising: a processor and a memory;
wherein the memory stores computer-executable instructions; and
the processor executes the computer-executable instructions stored in the memory, so as to cause the processor to perform a video frame prediction method, comprising:
obtaining first video frame information and second video frame information of a target video to be predicted, wherein the first video frame information comprises accumulation trend information of each historical video frame relative to a first video frame and transient variation information of each historical video frame relative to a last time video frame of the historical video frame, the historical video frame comprises a second time video frame to a t−1-th time video frame of the target video, and the second video frame information comprises encoding information of a t-th time video frame of the target video; wherein the t-th time is a current time and t is a positive integer;
predicting third video frame information of the t-th time video frame according to the first video frame information, the second video frame information and a video frame prediction model, wherein the third video frame information comprises accumulation trend information of the t-th time video frame relative to the first video frame and the transient variation information of the t-th time video frame relative to the t−1-th time video frame;
predicting a t+1-th time video frame of the target video according to the encoding information of the t-th time video frame and the third video frame information.

10. The electronic device according to claim 9, wherein the video frame prediction model comprises multiple layers of spatio-temporal attention cells arranged longitudinally;
correspondingly, the predicting the third video frame information of the t-th time video frame according to the first video frame information, the second video frame information and the video frame prediction model comprises:
for each layer of spatio-temporal attention cell, predicting the accumulation trend information of the t-th time video frame relative to the first video frame of the current layer and the transient variation information of the t-th time video frame relative to the t−1-th time video frame of the current layer according to a multi-scale attention fusion MAF model of the layer of spatio-temporal attention cell, the accumulation trend information of each historical video frame relative to the first video frame in the current layer, the transient variation information of each historical video frame relative to the last time video frame of the historical video frame in the current layer and encoding information of the t-th time video frame of the target video in the previous layer;
determining the accumulation trend information of the t-th time video frame relative to the first video frame of the last layer as the accumulation trend information of the t-th time video frame relative to the first video frame, and determining the transient variation information of the t-th time video frame relative to the t−1-th time video frame of the last layer as the transient variation information of the t-th time video frame relative to the t−1-th time video frame.

11. The electronic device according to claim 10, wherein the predicting the accumulation trend information of the t-th time video frame relative to the first video frame of the current layer and the transient variation information of the t-th time video frame relative to the t−1-th time video frame of the current layer according to the multi-scale attention fusion MAF model of the layer of spatio-temporal attention cell, the accumulation trend information of each historical video frame relative to the first video frame in the current layer, the transient variation information of each historical video frame relative to the last time video frame of the historical video frame in the current layer and the encoding information of the t-th time video frame of the target video in the previous layer comprises:
according to the multi-scale attention fusion MAF model, fusing the accumulation trend information of each historical video frame relative to the first video frame in the current layer and the transient variation information of each historical video frame relative to the last time video frame of the historical video frame in the current layer to determine first variation information of the t-th time video frame in the current layer in the time dimension; and determining second variation information of the t-th time video frame in the current layer in the spatial dimension according to the encoding information of the t-th time video frame in the previous layer and the transient variation information of the t−1-th time video frame relative to the t−2-th time video frame in the current layer;
predicting the accumulation trend information of the t-th time video frame relative to the first video frame of the current layer according to the first variation information, the second variation information and the accumulation trend information of the t−1-th time video frame relative to the first video frame of the current layer;
predicting the transient variation information of the t-th time video frame relative to the t−1-th time video frame of the current layer according to the accumulation trend information of the t-th time video frame relative to the first video frame of the current layer.

12. The electronic device according to claim 11, wherein the according to the multi-scale attention fusion MAF model, fusing the accumulation trend information of each historical video frame relative to the first video frame in the current layer and the transient variation information of each historical video frame relative to the last time video frame of the historical video frame in the current layer to determine the first variation information of the t-th time video frame in the current layer in the time dimension comprises:
determining an attention weight of each historical video frame in the current layer according to the transient variation information of each historical video frame relative to the last time video frame of the historical video frame in the current layer;
according to the attention weight of each historical video frame in the current layer, aggregating the accumulation trend information of the video frame at each historical time relative to the first video frame in the current layer in the time dimension, to determine a global motion trend of the t−1-th time video frame in the current layer in the time dimension;
combining the global motion trend of the t−1-th time video frame in the current layer in the time dimension and the accumulation trend information of the t−1-th time video frame relative to the first video frame in the current layer to determine the first variation information of the t-th time video frame in the current layer in the time dimension.

13. The electronic device according to claim 11, wherein the determining the second variation information of the t-th time video frame in the current layer in the spatial dimension according to the encoding information of the t-th time video frame in the previous layer and the transient variation information of the t−1-th time video frame relative to the t−2-th time video frame in the current layer comprises:
determining a first convolution operator corresponding to the encoding information of the t-th time video frame in the previous layer and a second convolution operator corresponding to the transient variation information of the t−1-th time video frame relative to the t−2-th time video frame in the current layer;
determining the second variation information of the t-th time video frame in the current layer in the spatial dimension according to a product of the encoding information of the t-th time video frame in the previous layer and the first convolution operator, a product of the transient variation information of the t−1-th time video frame relative to the t−2-th time video frame in the current layer and second convolution operator, and a local spatial information calculation model.

14. The electronic device according to claim 11, wherein the predicting the accumulation trend information of the t-th time video frame relative to the first video frame of the current layer according to the first variation information, the second variation information and the accumulation trend information of the t−1-th time video frame relative to the first video frame of the current layer comprises:
performing dot product operation on the accumulation trend information of the t−1-th time video frame relative to the first video frame of the current layer and the first variation information to obtain first vector information;
predicting the accumulation trend information of the t-th time video frame relative to the first video frame of the current layer according to a sum of the first vector information and the second variation information.

15. A non-transitory computer-readable storage medium, having computer-executable instructions stored thereon, the instructions, when executed by a processor, implement a video frame prediction method, comprising:
obtaining first video frame information and second video frame information of a target video to be predicted, wherein the first video frame information comprises accumulation trend information of each historical video frame relative to a first video frame and transient variation information of each historical video frame relative to a last time video frame of the historical video frame, the historical video frame comprises a second time video frame to a t−1-th time video frame of the target video, and the second video frame information comprises encoding information of a t-th time video frame of the target video; wherein the t-th time is a current time and t is a positive integer;
predicting third video frame information of the t-th time video frame according to the first video frame information, the second video frame information and a video frame prediction model, wherein the third video frame information comprises accumulation trend information of the t-th time video frame relative to the first video frame and the transient variation information of the t-th time video frame relative to the t−1-th time video frame;
predicting a t+1-th time video frame of the target video according to the encoding information of the t-th time video frame and the third video frame information.

16. The non-transitory computer-readable storage medium according to claim 15, wherein the video frame prediction model comprises multiple layers of spatio-temporal attention cells arranged longitudinally;
correspondingly, the predicting the third video frame information of the t-th time video frame according to the first video frame information, the second video frame information and the video frame prediction model comprises:
for each layer of spatio-temporal attention cell, predicting the accumulation trend information of the t-th time video frame relative to the first video frame of the current layer and the transient variation information of the t-th time video frame relative to the t−1-th time video frame of the current layer according to a multi-scale attention fusion MAF model of the layer of spatio-temporal attention cell, the accumulation trend information of each historical video frame relative to the first video frame in the current layer, the transient variation information of each historical video frame relative to the last time video frame of the historical video frame in the current layer and encoding information of the t-th time video frame of the target video in the previous layer;
determining the accumulation trend information of the t-th time video frame relative to the first video frame of the last layer as the accumulation trend information of the t-th time video frame relative to the first video frame, and determining the transient variation information of the t-th time video frame relative to the t−1-th time video frame of the last layer as the transient variation information of the t-th time video frame relative to the t−1-th time video frame.

17. The non-transitory computer-readable storage medium according to claim 16, wherein the predicting the accumulation trend information of the t-th time video frame relative to the first video frame of the current layer and the transient variation information of the t-th time video frame relative to the t−1-th time video frame of the current layer according to the multi-scale attention fusion MAF model of the layer of spatio-temporal attention cell, the accumulation trend information of each historical video frame relative to the first video frame in the current layer, the transient variation information of each historical video frame relative to the last time video frame of the historical video frame in the current layer and the encoding information of the t-th time video frame of the target video in the previous layer comprises:
according to the multi-scale attention fusion MAF model, fusing the accumulation trend information of each historical video frame relative to the first video frame in the current layer and the transient variation information of each historical video frame relative to the last time video frame of the historical video frame in the current layer to determine first variation information of the t-th time video frame in the current layer in the time dimension; and determining second variation information of the t-th time video frame in the current layer in the spatial dimension according to the encoding information of the t-th time video frame in the previous layer and the transient variation information of the t−1-th time video frame relative to the t−2-th time video frame in the current layer;
predicting the accumulation trend information of the t-th time video frame relative to the first video frame of the current layer according to the first variation information, the second variation information and the accumulation trend information of the t−1-th time video frame relative to the first video frame of the current layer;
predicting the transient variation information of the t-th time video frame relative to the t−1-th time video frame of the current layer according to the accumulation trend information of the t-th time video frame relative to the first video frame of the current layer.

18. The non-transitory computer-readable storage medium according to claim 17, wherein the according to the multi-scale attention fusion MAF model, fusing the accumulation trend information of each historical video frame relative to the first video frame in the current layer and the transient variation information of each historical video frame relative to the last time video frame of the historical video frame in the current layer to determine the first variation information of the t-th time video frame in the current layer in the time dimension comprises:
determining an attention weight of each historical video frame in the current layer according to the transient variation information of each historical video frame relative to the last time video frame of the historical video frame in the current layer;
according to the attention weight of each historical video frame in the current layer, aggregating the accumulation trend information of the video frame at each historical time relative to the first video frame in the current layer in the time dimension, to determine a global motion trend of the t−1-th time video frame in the current layer in the time dimension;
combining the global motion trend of the t−1-th time video frame in the current layer in the time dimension and the accumulation trend information of the t−1-th time video frame relative to the first video frame in the current layer to determine the first variation information of the t-th time video frame in the current layer in the time dimension.

19. The non-transitory computer-readable storage medium according to claim 17, wherein the determining the second variation information of the t-th time video frame in the current layer in the spatial dimension according to the encoding information of the t-th time video frame in the previous layer and the transient variation information of the t−1-th time video frame relative to the t−2-th time video frame in the current layer comprises:
determining a first convolution operator corresponding to the encoding information of the t-th time video frame in the previous layer and a second convolution operator corresponding to the transient variation information of the t−1-th time video frame relative to the t−2-th time video frame in the current layer;
determining the second variation information of the t-th time video frame in the current layer in the spatial dimension according to a product of the encoding information of the t-th time video frame in the previous layer and the first convolution operator, a product of the transient variation information of the t−1-th time video frame relative to the t−2-th time video frame in the current layer and second convolution operator, and a local spatial information calculation model.

20. The non-transitory computer-readable storage medium according to claim 17, wherein the predicting the accumulation trend information of the t-th time video frame relative to the first video frame of the current layer according to the first variation information, the second variation information and the accumulation trend information of the t−1-th time video frame relative to the first video frame of the current layer comprises:
performing dot product operation on the accumulation trend information of the t−1-th time video frame relative to the first video frame of the current layer and the first variation information to obtain first vector information;
predicting the accumulation trend information of the t-th time video frame relative to the first video frame of the current layer according to a sum of the first vector information and the second variation information.
